(19) United States
(12) Patent Application Publication
(10) Pub. No.: US 2002/0071881 A1
(43) Pub. Date: Jun. 13, 2002

(54) Apparatus and method for manufacturing fiber gratings

(76) Inventors: Victor Il?apos;ich Kopp, Flushing, NY (US); Azriel Zelig Genack, New York, NY (US); Richard Mead, Los Altos Hills, CA (US)

Correspondence Address: Edward Etkin, Esq., Suite 3C, 4804 Bedford Avenue, Brooklyn, NY, 11235, US

(21) Appl. No.: 09/925,590

(22) Filed: Aug. 9, 2001

Related U.S. Application Data
(60) Provisional application No. 60/224,221, filed on Aug. 9, 2000.
(60) Provisional application No. 60/233,506, filed on Sep. 19, 2000.

(51) Int. Cl. B29C 47/34

(52) U.S. Cl. 425/66

(57) ABSTRACT

In accordance with the apparatus and method of the present invention an optical fiber is heated and twisted to produce a periodic modulation of the dielectric constant along the fiber axis. This structure can be used in any application that utilizes Bragg grating optical fibers. A preform is drawn through a heater and the resulting optical fiber is twisted about its longitudinal axis. The refractive index modulation in the optical fiber arises from birefringence induced by stress in the optical fiber that is twisted after being subjected to an uneven heat distribution during the drawing process. The refractive index is modulated by drawing and twisting the optical fiber from a specially constructed preform which is non-cylindrically symmetrical.

### CROSS REFERENCE TO RELATED APPLICATIONS

The present patent application claims priority from the commonly assigned U.S. provisional patent application Ser. No. 60/224,221 entitled “Apparatus and Method for Manufacturing Periodic Grating Optical Fibers,” filed Aug. 9, 2001 and from the commonly assigned U.S. provisional patent application Ser. No. 60/233,506 entitled “Apparatus and Method for Manufacturing Periodic Grating Optical Fibers from Multiple Glass Elements,” filed Sep. 19, 2001.

### FIELD OF THE INVENTION

The present invention relates generally to periodic optical fibers, and more particularly to an apparatus and method for manufacturing various configurations of fiber gratings.

### BACKGROUND OF THE INVENTION

Bragg grating optical fibers have a wide variety of applications in photonics, and are especially useful in the telecommunications field. Fiber Bragg gratings have been utilized in laser, amplifier, filter and WDM applications.

The conventional method of manufacture is based on photo-induced changes of the refractive index. One approach requires fine alignment of two interfering laser beams along the length of the optical fiber. Extended lengths of period fiber are produced by moving the fiber and re-exposing it to the interfering illumination wire carefully aligning the interference pattern to be in phase with the previously written periodic modulation. The fiber core utilized in the process must be composed of specially prepared photorefractive glass, such as germanium doped silicate glass. This approach limits the length of the resulting grating and also limits the index contrast produced. Furthermore such equipment requires perfect alignment of the interfering lasers and exact coordination of the fiber over minute distances when it is displaced prior to being exposed again to the laser interference pattern. Another approach to fabricating fiber Bragg gratings involves the use of a long phase mask placed in a fixed position relative to a fiber workpiece before it is exposed to the UV beam. This approach requires photosensitive glass fibers and also requires manufacture of a specific mask for each type of fiber Bragg grating produced. Furthermore, the length of the produced fiber is limited by the length of the mask unless the fiber is displaced and re-aligned with great precision. This restricts the production of fiber Bragg gratings to relatively small lengths making the manufacturing process more time consuming and expensive.

It would thus be desirable to provide a manufacturing apparatus and method for easily, cheaply and accurately producing an optical fiber with a periodic (i.e. Bragg) grating. It would also be desirable to provide a method for configuring the inventive apparatus and raw materials to produce optical fibers with a variety of properties for different applications. It would further be desirable to provide an apparatus and method for manufacturing periodic grating fibers of lengths greater than can be produced with acceptable quality utilizing previously known techniques.

### SUMMARY OF THE INVENTION

The inventive apparatus advantageously provides a method for modulating the refractive index of an optical fiber by drawing a preform through a heater and twisting the resulting optical fiber about its longitudinal axis. The refractive index modulation in the optical fiber arises from birefringence induced by stress in the optical fiber that is twisted after being subjected to an uneven heat distribution during the drawing process. Alternatively, refractive index modulation may be induced by drawing and twisting the optical fiber from a specially constructed non-cylindrically symmetric preform, for example, a preform containing longitudinally inscribed grooves, or containing at least one longitudinal cavity, or formed from multiple materials with different optical properties, or formed from multiple perform elements in contact with one another, or any combination of the above.

The inventive apparatus and method advantageously overcome the drawbacks of previously known fiber Bragg grating manufacturing techniques, thereby greatly simplifying the fabrication process by eliminating precise irradiation of the fiber and reducing the cost. Furthermore, the inventive apparatus and method enable a great deal of control over the fabrication of fiber Bragg gratings and make it possible to produce fibers with different pitch and diameter characteristics from the same preforms.

The preferred embodiment of the present invention includes a feeding unit for feeding the preform, a heater for heating the preform to a temperature sufficient to enable the preform to be drawn and twisted, a drawing/twisting unit for drawing the preform through the heater and twisting it at a predefined twisting speed to form an optical fiber with refractive index modulation along its length. Preferably, the speed at which the preform is being fed by the feeding unit is slower that the speed at which the fiber is being drawn from the preform. The relationship between the feeding and drawing speeds determined the diameter of the resulting optical fiber, while the relationship between the drawing speed and the twisting speed determines the pitch of the resulting fiber. Thus, a variety of fiber Bragg grating with different diameter and pitch characteristics may be advantageously produced from a set of identical preforms by varying the feeding, drawing and rotating speeds.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### BRIEF DESCRIPTION OF THE DRAWINGS

In the drawings, wherein like reference characters denote elements throughout the several views:

FIG. 1A is a schematic diagram of a first embodiment of a manufacturing apparatus of the present invention shown in an initial pre-operation state;

FIG. 1B is a schematic diagram of the manufacturing apparatus of the present invention of FIG. 1A showing drawing and twisting of an optical fiber from a preform;

FIG. 2A is a schematic diagram of a second embodiment of a manufacturing apparatus of the present invention shown in an initial pre-operation state;

FIG. 2B is a schematic diagram of the manufacturing apparatus of the present invention of FIG. 2A showing drawing and twisting of an optical fiber from a preform;

FIG. 3A is a schematic diagram of a first embodiment of a tensioning apparatus used with the manufacturing apparatus of the present invention;

FIG. 3B is a schematic diagram of a second embodiment of a tensioning apparatus used with the manufacturing apparatus of the present invention;

FIGS. 4A-4H are top view cross-section diagrams showing various configurations of the preform utilized in the apparatus of FIGS. 1A-1B and the apparatus of FIGS. 2A-2B;

FIG. 5A is a schematic diagram and a graph showing a first heat distribution scheme in a first embodiment of a heating apparatus used in the manufacturing apparatus of the present invention.

FIG. 5B is a schematic diagram and a graph showing a second heat distribution scheme in a second embodiment of a heating apparatus used in the manufacturing apparatus of the present invention.

FIG. 6A is a schematic diagram showing a top-view cross-section of a third embodiment of the heating apparatus used in the manufacturing apparatus of the present invention; and

FIG. 6B is a schematic diagram showing a top-view cross-section of a fourth embodiment of the heating apparatus used in the manufacturing apparatus of the present invention.

### DETAILED DESCRIPTION OF PREFERRED EMBODIMENTS

The inventive apparatus advantageously provides a method for modulating the refractive index of an optical fiber by drawing a preform through a heater and twisting the resulting optical fiber about its longitudinal axis. The refractive index modulation in the optical fiber arises from birefringence induced by stress in the optical fiber that is twisted after being subjected to an uneven heat distribution during the drawing process. Alternatively, the refractive index modulation may be induced by drawing and twisting the optical fiber from a specially constructed preform, for example, a preform containing longitudinally inscribed grooves, or containing at least one longitudinal cavity, or formed from multiple materials with different optical properties, or formed from multiple perform elements in contact with one another, or any combination of the above.

In summary, in accordance with the present invention, a preform is heated, drawn, and twisted to produce an optical fiber with a periodic modulation of the dielectric constant along the fiber axis. The resulting structure may be used, for example, as a an add-drop filter component in WDM systems, or, when the preform is doped with an active dopant, such as Er ions, to provide feedback for a laser or an optical amplifier.

The inventive fabrication apparatus utilizes a “preform” or a glass element of suitable quality to be formed into an optical fiber. Preferably, the preform is prepared before utilization in the inventive apparatus from a glass workpiece to conform to a suitable diameter and length selected as a matter of design choice based on the desirable length and diameter for the resulting optical fiber. The pre-process preparation may be accomplished by a variety of well known glass element drawing techniques. For example, a 2 cm diameter 30 cm long workpiece may be drawn into one or several 70 micron diameter preforms of smaller or much greater lengths. It should be understood that the workpiece must be prepared with any physical characteristics or attributes (such as composition from several materials, inscribed longitudinal grooves or internal holes) that are desired in the preform. The prepared preforms may then be advantageously utilized in the apparatus of the present invention.

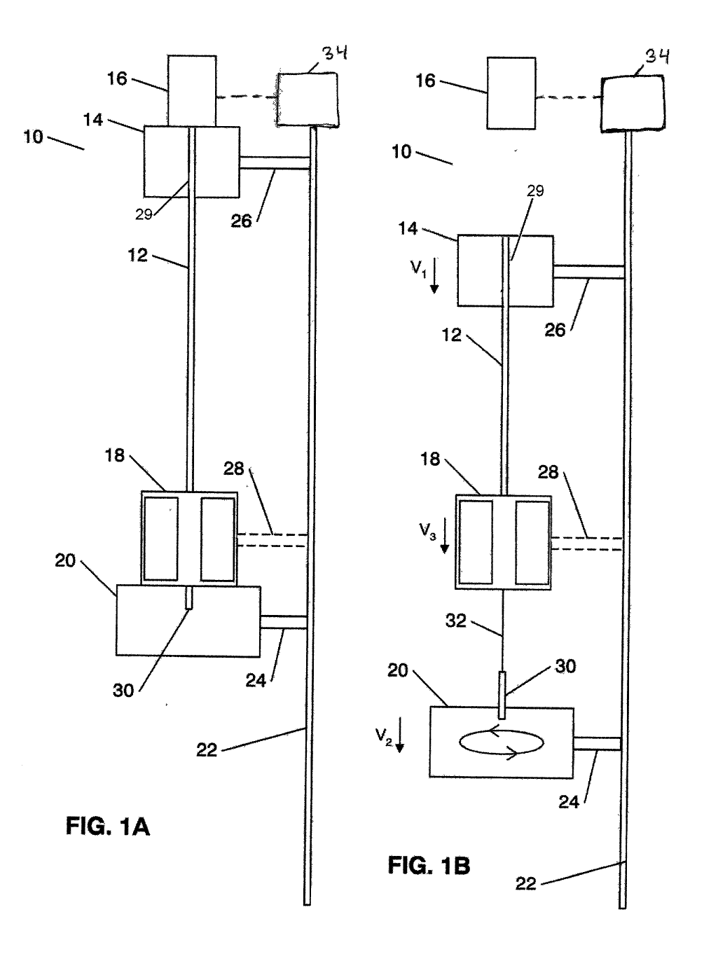

Referring now to FIGS. 1A and 1B, a first embodiment of the inventive manufacturing apparatus 10 is shown. FIG. 1A shows the apparatus 10 in a pre-operation initial state. A preform 12 is positioned within the apparatus 10 with its first end 29 at the upper portion of the apparatus 10 and its second end 30 at the bottom portion of the apparatus 10. The apparatus 10 comprises a feeder unit 14 for retaining the first end 29 of the preform 12 and for feeding the preform 12 during the operation of the apparatus 10, a tensioning unit 16 for imposing a predefined tension on the preform 12, a heater 18 for heating the preform 12 to a sufficient process temperature to enable drawing and twisting of the preform, and a drawing/twisting unit 20 for securing the second end 30 of the preform 12 and for drawing and twisting the preform 12 into an optical fiber 32 (as described in greater detail in connection with FIG. 1B below). The apparatus 10 also comprises a translation unit 22 with the feeder unit 14 and the drawing/twisting unit 20 connected to the translation unit 22 by respective linearly mobile members 26, 24, such that the feeder unit 14 and the drawing/twisting unit 20 may move in either direction along the translation unit 22. Optionally, the heater 18 may be connected to the translation unit 22 via a linearly mobile member 28 such that the heater 18 may also move in either direction along the translation unit 22. The apparatus 10 also includes a control unit 34 connected to the drawing unit 14, the heater 18, the drawing/twisting unit 20, the translation unit 22, and optionally to the tensioning unit 16, for controlling the operation and parameters of the apparatus 10.

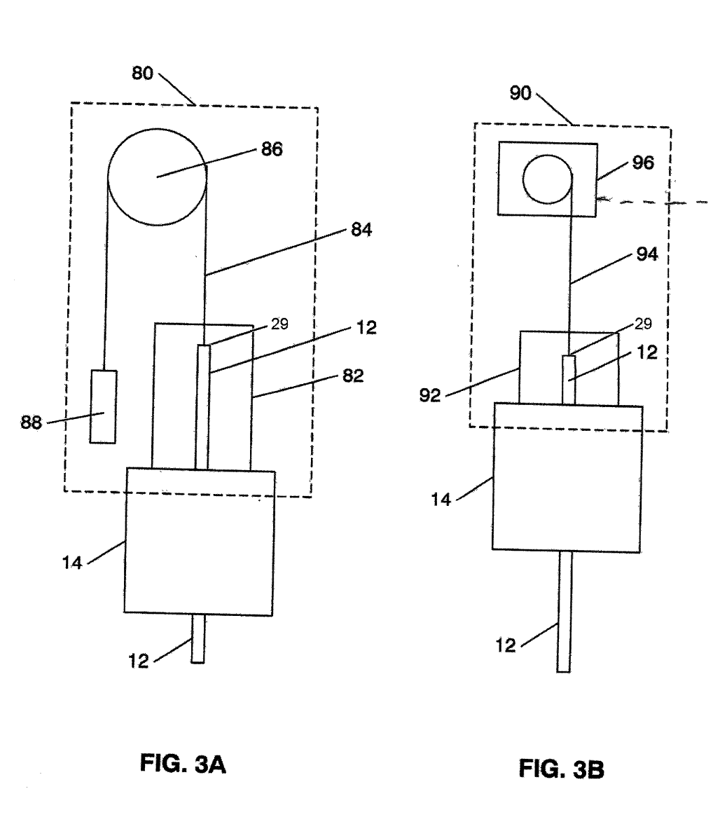

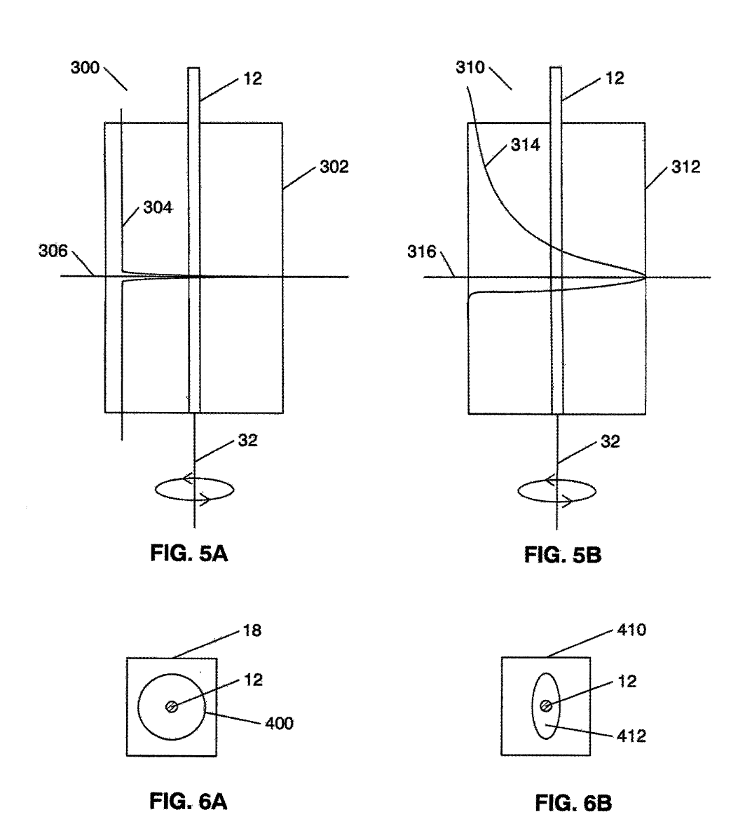

The feeder unit 14 may be a releasable gripping device 82 (see FIG. 3A) or any other device capable of selectively retaining the preform 12. The tensioning unit 16 is described in greater detail below in connection with FIGS. 3A and 3B. The heater 18 may be any heater capable of reaching a temperature in its heating chamber (not shown) sufficient to place the preform 12 in a state suitable for drawing and twisting. Different embodiments of the heater 18 are described below in connection with FIGS. 5A to 6B. The drawing/twisting unit 20 may comprise a chuck (not shown) for selectively retaining the second end 30 of the preform 12, and a motor (not shown) for rotating the chuck at a predefined twisting speed in response to a signal from the control unit 34. The translation unit 22 may be an elongated linear translation stage of a type well know in the art with the members 24, 26, 28 comprising linearly mobile devices that may be moved in either direction along the translation unit 22 in response to signals from the control unit 34.

Preferably, the control unit 34 controls the operation of the apparatus 10 in three sequential stages: a tensioning stage, a start-up stage, and a process stage. At the tensioning stage (shown in FIG. 1A) of the process, the first end 29 of the preform 12 is connected to the tensioning unit 16 and the second end 30 of the preform 12 is passed through the heater 18 and secured at the drawing/twisting unit 20. The control unit 34 then causes the tension unit 16 to pull the first end 29 of the preform 12 until a predefined tension value is reached. The tension value is selected as a matter of design choice based on the characteristics (i.e. size, composition) of the preform 12 used. However, the tension value should be sufficient to prevent the preform from loosening up and oscillating during the process stage. After the desired tension value is reached, the first end 29 of the preform 12 is secured by the feeder unit 14. The initial position of the heater 18 is at the lowest portion of the preform 12 as close as possible to the second end 30 to minimize waste, as any portion of the preform 12 that begins the process under the heater is wasted.

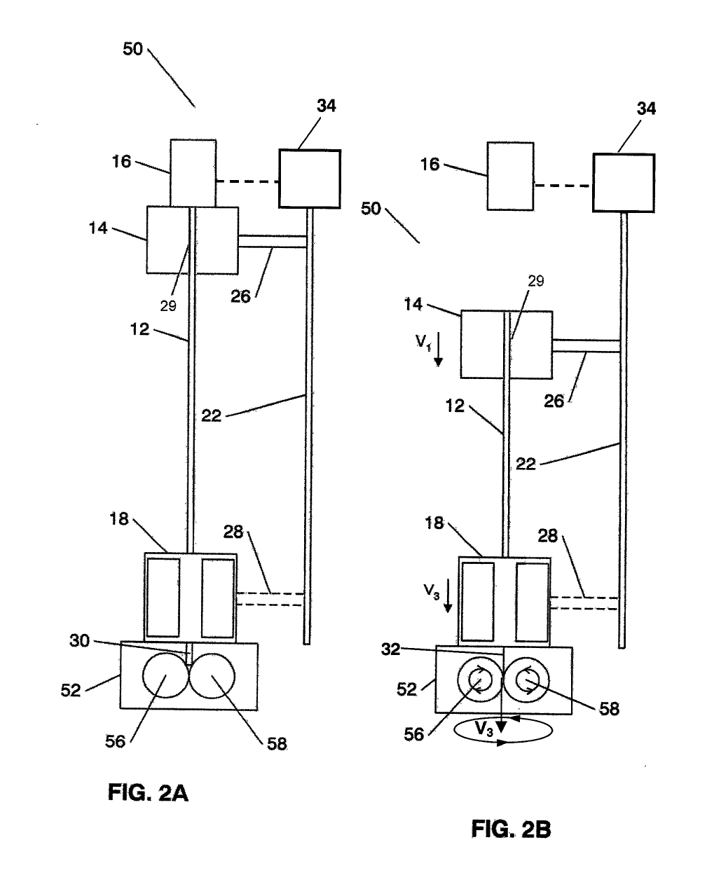

Prior to initiating the start-up stage, several values must be selected by the process operator to determine the desirable properties—the diameter and the pitch—of the modulated refractive index optical fiber produced by the apparatus 10. The desired diameter of the fiber D_{f} is determined by the following expression:

$${D}_{f} = {D}_{p} \sqrt{\frac{{V}_{f}}{{V}_{d}}}$$

Where Dₚ is the diameter of the preform, V_{f} is the speed at which the preform 12 is fed, and V_{d} is the speed at which the preform 12 is drawn. Thus, in order to achieve a desired diameter of the fiber D_{f} given a preform 12 of diameter Dₚ specific values of V_{f} and V_{d} must be selected. For example if V_{f} is set to 1 cm/sec, V_{d} is set to 2 cm per second, and the diameter Dₚ of the preform is 70 microns, the diameter D_{f} of the resulting fiber will be approximately 49.5 microns. If the heater 18 is mobile via the member 28, then V_{f} may be expressed as (V₁−V₃) where V₁ is the speed at which the feeder unit 14 feeds the preform 12, and where V₃ is the speed of the heater 18. The arrows in FIGS. 1B and 2B denote the direction taken as positive and may not indicate the actual direction of the motion. Similarly, V_{d} may be expressed as (V₂ −V₃) where V₂ is the speed at which the drawing/twisting unit 20 draws the preform 12. In an alternate embodiment, the feeder unit 14 is immobile, and thus V₁ is zero. In this case, since V_{f} must remain constant and positive, V₃ is set to be equal to V_{f} but the direction of V₃ is changed to be opposite to V_{d}. It should thus be noted that the arrangements of the movable components of the apparatus 10 are shown by way of example only. Different methods of keeping certain components stationary while moving others, and different values for V₁, V₂, and V₃ may be selected as a matter of design choice, as long as the expression for the desired diameter D_{f} shown above is substantially adhered to.

The desired pitch P of the modulated refractive index optical fiber produced by the apparatus 10 is determined by the following expression:

$$P = \frac{{V}_{d}}{R}$$

Where V_{d} is the speed at which the preform 12 is drawn and R is the number of revolutions per unit of time at which the preform 12 is twisted to produce the fiber 32.

Referring now to FIG. 1B, once the values for V_{f}, V_{d}, and R have been selected, the control unit 34 begins the start-up stage of the process. During the start-up stage of the process, the feeder unit begins to move downward at a speed V₁, to feed the preform 12 through the heater 18 and the drawing/twisting unit 20 simultaneously begins to move downward at a speed V₂ pulling the preform through the heater. At the same time, the control unit 34 causes the temperature inside the heater 18 to increase from room temperature to a predefined process temperature. Initially, V₁, is equal to V₂ however, the control unit 34 decreases V₁, as the heater 18 temperature rises to the process temperature, such that V₁, is equal to the desired V_{f} once the heater 18 temperature is equal to the process temperature. At this point, a portion of the preform 12 inside the heater 18 is heated to a state at which it can be drawn and twisted and the process stage begins.

At the beginning of, and during the process stage, the difference in speeds between V_{f} and V_{d} causes the fiber 32 to be drawn out of the heater 18 and at the same time, the control unit 34 causes the drawing/twisting unit 20 to twist around the preform 12 longitudinal axis at the predefined rotation speed R. The twisting and drawing process thus may continue until the entire preform, other than the first end 29, is drawn through the heater 18 and twisted. As described above, in an alternate embodiment, V₁, may be set to zero, in which case the heater 18 moves along the preform 12 with a speed V₃ in the opposite direction of the movement of the drawing/twisting unit 20. In this case V₃ starts out equal to V₂ but in the opposite direction, and reaches V_{f} when the temperature in the heater 18 reaches the process temperature. Thus, a modulated refractive index optical fiber 32—i.e. a fiber Bragg grating is advantageously produced in accordance with the present invention. The inventive apparatus 10 and process enable considerable control over desired optical fiber 32 characteristics (diameter D_{f} and pitch P) simply by varying such parameters as V_{f}, V_{d}, and R, and thus different fiber Bragg gratings may be produced from an identical set of preforms 12. Furthermore, the inventive apparatus 10 does not utilize any precise irradiation of the optical fiber and is not limited by the size and/or construction of a mask.

Referring now to FIGS. 2A-2B, a second embodiment of the inventive apparatus 10 is shown as a manufacturing apparatus 50. FIG. 2A shows the apparatus 50 during the tensioning stage, while FIG. 2B shows the apparatus 50 during the start-up and process stages. The apparatus 50, and its elements are substantially identical to the apparatus 10, with the difference being that the drawing/twisting unit 20 of FIGS. 1A and 1B is replaced by a drawing/twisting unit 52 that is not connected to the translation unit 22. Instead of the drawing/twisting unit 22 moving along the translation unit 22, the drawing/twisting unit 52 draws the preform 12 through itself, for example, by use of drawing wheels 56 and 58. During the start-up stage, the wheels 56, 58 engage and retain the second end 30 of the preform 12, and once the start-up stage begins, the drawing wheels 56, 58 begin to turn in opposite directions, as shown in FIG. 2B, to draw the preform 12 through the drawing twisting/unit 52 at the drawing speed V_{d}. Then, when the process stage begins, the drawing/twisting unit 52 begins to spin around the longitudinal axis of the preform 12 in order to twist the fiber 32 in the same manner as the drawing/twisting unit 20 of FIGS. 1A-1B.

It should be noted that other known techniques of feeding and drawing fibers may be utilized in the apparatus 10 and 50 without departing from the spirit of the present invention. For example, in apparatus 50, the translation unit 22 may be eliminated and the feeder unit 14 may be replaced by an immobile feeding device similar to the drawing/twisting unit 52 that feeds the preform 12 therethrough at the speed V_{f} (not shown). In this case, the preform 12 need not be secured by the feeder unit 14 and may be freely fed through the feeder unit 14 to a desired length.

While the tensioning unit 16 may be selected as matter of design choice from a variety of tensioning approaches, two tensioning techniques have been utilized with great effectiveness in conjunction with the apparatus 10 and 50 of the present invention. Referring now to FIG. 3A, a first embodiment of the tensioning unit 16 is shown as tensioning unit 80. The tensioning unit 80 includes a wheel 86 configured to freely rotate around an axis perpendicular to the longitudinal axis of the preform 12, a line 84 looped around the wheel 86, where one end of the line 84 is attached to the first end 29 of the preform 12 and where the second end is attached to a counterweight 88 of a predefined magnitude selected to apply a predefined desired tension to the preform 12. Once the tensioning stage is complete, the first end 29 of the preform 12 is secured within the feeder unit 14 by the gripping device 82 and then optionally disconnected from the line 84.

In an alternate embodiment of the tensioning unit 80, the line 84 may be eliminated, and the preform 12 may be looped around the wheel 86 and attached to the counterweight 88 by the first end 29 directly (not shown). In this case, when the tensioning stage is complete, a portion of the preform 12 within the feeder unit 14 is secured and the excess portion of the preform 12 looping around the wheel 86 is severed. While this approach eliminates the need for the line 84, it causes a portion of the preform 12 to be wasted.

Referring now to FIG. 3B, a second embodiment of the tensioning unit 16 is shown as tensioning unit 90. The tensioning unit 90 includes, a line 94 connected at one end to the first end 29 of the preform 12 and at the other end to a motor unit 96. The motor unit 96 is preferably configured to pull the line 94 sufficiently to apply the desired predefined tension to the preform 12. Once the tensioning stage is complete, the first end 29 of the preform 12 is secured within the feeder unit 14 by a gripping device 92 and then optionally disconnected from the line 84.

In an alternate embodiment of the tensioning unit 90, the line 94 may be eliminated, and the preform 12 may be directly connected to the motor unit 96 (not shown) via the first end 29. In this case, when the tensioning stage is complete, a portion of the preform 12 within the feeder unit 14 is secured, and the excess portion of the preform 12 between the gripping device 92 and the motor unit 96 is severed. While this approach eliminates the need for the line 94, it causes a portion of the preform 12 to be wasted.

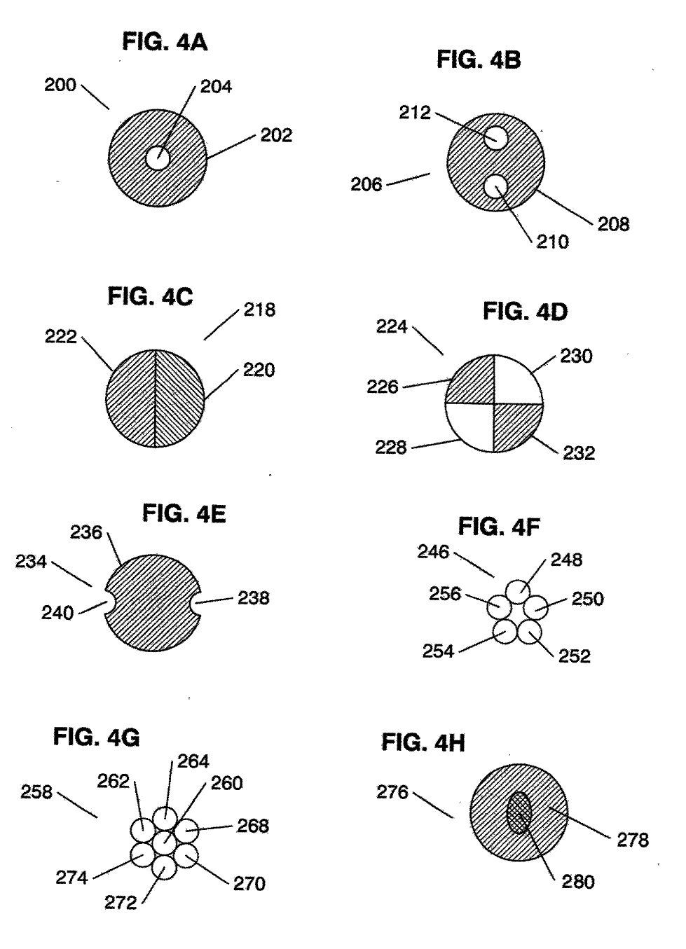

Referring now to FIGS. 4A to 4H, a number of different preform 12 configurations are shown by way of example. Referring now to FIG. 4A, a preform 200 is shown having a body 202 composed of a glass material and an axial cavity running along the central longitudinal axis thereof. Optionally, the axial cavity 204 may be filled with a second glass material having optical properties different from those of the body 202.

Referring now to FIG. 4B, a preform 206 is shown having a body 208 composed of a glass material and two axial cavities 210, 212 running parallel to the central longitudinal axis thereof but at a symmetrical distance from the central axis of the body 208. Optionally, the axial cavities 210, 212 may be filled with a second glass material having optical properties different from those of the body 208. While only two cavities are shown, it should be understood that multiple longitudinal cavities may be defined in the preform body 208 as a matter of design choice without departing from the spirit of the present invention.

Referring now to FIG. 4C, a preform 218 is shown. The preform 218 is composed of a first half-cylindrical portion of a first material 220 parallel to a second half-cylindrical portion of a second material 222, where the flat sections of the first portion 220 and the second portion 222 are in contact with one another, and where each of the first and second materials have different optical properties.

Referring now to FIG. 4D, a preform 224 is shown. The preform 2224 is composed of a first quarter-cylindrical portion 226 of a first material in contact on each side with a second and third quarter cylindrical portions 228, 230 composed of a second material, and a fourth quarter-cylindrical portion 232 of the first material contacting its sides with the second and third quarter cylindrical portion 228, 230 sides that are not in contact with the first quarter-cylindrical portion 226 except at the center; where all vertices of the first, second, third and fourth quarter-cylindrical portions 226, 228, 230 and 232 respectively, are aligned with the preform 224 central longitudinal axis. Preferably, each of the first and second materials have different optical properties.

Referring now to FIG. 4E, a preform 234 is shown having a body 236 composed of a glass material and two surface grooves 238, 260 running parallel to the central longitudinal axis of the body 236. While only two grooves are shown, it should be understood that multiple longitudinal grooves may be inscribed on the surface of the preform body 236 as a matter of design choice without departing from the spirit of the present invention.

Referring now to FIG. 4F, a preform 246 is shown composed of multiple glass elements 248 through 256 arranged to form a cavity along the longitudinal axis of the preform 246. While only five glass elements are shown, it should be understood that more or fewer glass elements may be utilized as a matter of design choice without departing from the spirit of the present invention.

Referring now to FIG. 4G, a preform 258 is shown composed of multiple glass elements 260 through 274, with elements 262, 264, 266, 268, 270, 272 and 274 arranged circumferentially around element 260 disposed along a central longitudinal axis of the preform 258. While only seven glass elements are shown, it should be understood that more or fewer glass elements may be utilized as a matter of design choice without departing from the spirit of the present invention.

Referring now to FIG. 4H, a preform 276 is shown having a cladding 278 composed of a first material and an axial core 280 of a second material running along the central longitudinal axis thereof. Preferably, the core 280 has an elliptical or rectangular cross-section.

It should be noted that other configurations that may comprise combinations of one or more preform configurations shown and described herein may be used as a matter of design choice without departing from the spirit of the present invention. For example, the present invention may include an embodiment of the preform 200 where the central cavity 204 is filled with a core, the core having two surface grooves, as shown in FIG. 4E.

Having a desirable heat distribution within the heater 18 is important. Referring now to FIG. 5A, a preferred embodiment of the heater 18 is shown as a heater 300. The heater 300 includes a heat distribution control 302 for controlling a longitudinal heat distribution along the preform 12 within the heater 300, shown by a graph 304, and for controlling the transverse heat distribution perpendicular to the preform 12 within the heater 300, shown by a graph 306. The heat distribution control may be a set of insulating materials arranged within the heater, a set of active air and/or liquid cooling devices within the heater, or a combination of both. Preferably, the longitudinal heat distribution 304 within the heater 300 peaks sharply at a central portion of the heater 300 corresponding to the area in which the preform 12 is drawn into the fiber 32 and twisted. Also, preferably, the transverse heat distribution 306 is kept as flat as possible such that if the preform 12 and fiber 32 vibrate, they are still subjected to a uniform temperature. The purpose of the heat distribution control 302 is to shift the peak of the longitudinal heat distribution 304 to a central portion of the heater 300 and to keep the transverse heat distribution 306 as flat as possible.

Referring now to FIG. 5B, an alternate embodiment of the heater 18 is shown as a heater 310. The heater 310 includes a heat distribution control 312 for controlling a longitudinal heat distribution along the preform 12 within the heater 310, shown by a graph 314, and for controlling the transverse heat distribution perpendicular to the preform 12 within the heater 310, shown by a graph 316. The heat distribution control may be a set of insulating materials arranged within the heater, a set of active air and/or liquid cooling devices within the heater, or a combination of both. Preferably, the longitudinal heat distribution 314 within the heater 310 increases gradually from room temperature at the top portion of the heater 310 to a peak at a central portion of the heater 300 corresponding to the region in which the preform 12 is drawn into the fiber 32 and twisted. The longitudinal heat distribution 314 preferably drops off sharply after the central portion of the heater 310. Also, preferably, the transverse heat distribution 316 is kept as flat as possible such that if the preform 12 and fiber 32 begin oscillating they are subjected to the same temperature.

While a variety of specially prepared preform configurations are shown in FIGS. 4A to 4H, a solid glass preform 12 may be utilized as well if the heater 18 is configured to apply heat unevenly to the preform 12 to thus induce symmetrical changes in optical characteristics of in opposed portions of the preform 12. Referring to FIG. 6A, a first embodiment of the heater 18 is shown having a uniform heating chamber 400 surrounding the preform 12. The circular cross-section and relative size of the heat chamber are shown by way of example only and may vary in size or shape as a matter of design choice. This embodiment of the heater 18 may be utilized with preform 12 using configurations shown in FIGS. 4A to 4H or combinations thereof. However, a plain solid preform 12 twisted and drawn in the heater 18 would not produce the desirable modulation of the refractive index within the fiber 32.

Referring now to FIG. 6B, a second embodiment of the heater 18 is shown as heater 410. A heating chamber 412 is shaped with two-fold symmetry such that heat is applied unevenly to preform 12. This spatial variation in heating gives rise to stress within the preform 12 such that, when the preform 12 is drawn and twisted into the fiber 32, the refractive index of the fiber 32 is modulated along the fiber length. Optionally, any of the preform 12 configurations shown in FIGS. 4A to 4H may also be utilized in the heater 410.

Thus, while there have been shown and described and pointed out fundamental novel features of the invention as applied to preferred embodiments thereof, it will be understood that various omissions and substitutions and changes in the form and details of the devices and methods illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. It is the intention, therefore, to be limited only as indicated by the scope of the claims appended hereto.

We claim:

1. An apparatus for utilizing a preform, having a first end and a second end, to manufacture an optical fiber having a modulation of the dielectric constant along its longitudinal axis, the apparatus comprising:
feeding means for:
securing the first end of the preform, and
feeding the preform at a predefined feeding speed;
heating means, arranged sequentially to said feeding means, for receiving the preform and for heating the preform to a predefined process temperature at a predefined heating location, said process temperature being sufficient to cause the preform to be susceptible to drawing and twisting; and
drawing means, arranged sequentially to said heating means, for:
engaging the second end of the preform;
drawing the preform from said feeding means through said heating means at a predefined drawing speed to produce the optical fiber drawn from the preform at said predetermined location within said heating means, said drawing speed being one greater than or equal to said feeding speed; and
twisting the optical fiber around the longitudinal axis at a predefined twisting speed, at said predetermined location, to produce a twisted optical fiber having a periodic modulation of the dielectric constant along the longitudinal axis.

2. The apparatus of claim 1, wherein the preform comprises at least one of:
(a) at least one hole along the longitudinal axis;
(b) at least one groove in the surface of the preform along the longitudinal axis;
(c) a first elongated quarter-cylindrical portion comprised of a first material, a second elongated quarter-cylindrical portion comprised of a second material, in contact with said first portion, a third elongated quarter-cylindrical portion comprised of a first material in contact with said second portion, and a fourth elongated quarter-cylindrical portion comprised of a second material in contact with said third and said first portions, said first, second, third and fourth portions being arranged clockwise starting from said first portion;
(d) a first elongated half-cylindrical portion comprised of a first material and a second elongated half-cylindrical portion comprised of a second material, said first and second portions having their flat surfaces in contact with one another;
(e) at least two elongated elements in contact with one another along a common longitudinal axis; and
(f) an outer cladding material and an inner core material along a central longitudinal axis, said outer cladding material having a circular cross-section, and said inner core material having one of: an elliptical cross-section and a rectangular cross-section.

3. The apparatus of claim 1, further comprising a control unit connected to said feeding means, said heating means, and said drawing means, said control unit being operable to: control and vary at least one of: said predefined feeding speed, said predefined process temperature, said predefined drawing speed and said predefined twisting speed.

4. The apparatus of claim 3, further comprising a translation means connected to said control unit, wherein said feeding means and said drawing means are each configured to move along said translation means, and wherein said control unit is operable to:
(a) cause said feeding means to move along said translation means at said feeding speed; and
(b) cause said drawing means to move along said translation means at said drawing speed.

5. The apparatus of claim 3, further comprising a translation means connected to said control unit, wherein said feeding means are configured to move along said translation means, and wherein said control unit is operable to:
(a) cause said feeding means to move along said translation means at said feeding speed; and
(b) cause said drawing means to draw the optical fiber from the heating means at said drawing speed.

6. The apparatus of claim 3, further comprising a translation means connected to said control unit, wherein said feeding means, said heating means, and said drawing means are each configured to move along said translation means, and wherein said control unit is operable to:
(a) cause said feeding means to move along said translation means at a first speed;
(b) cause said heating means to move along said translation means at a second speed; and
(c) cause said drawing means to move along said translation means at a third speed, wherein said first speed, said second speed, and said third speed are selected having magnitude and direction such that:
the difference between said first speed and said second speed is substantially equal in magnitude and direction to said feeding speed, and
the difference between said third speed and said second speed is substantially equal in magnitude and direction to said drawing speed.

7. The apparatus of claim 1, further comprising tensioning means for imposing a predefined tension on the preform, prior to activation of said feeding means, said heating means, and said drawing means.

8. The apparatus of claim 7, wherein said tensioning means further comprises:
securing means for securing the second end of the preform; and
pulling means for pulling the first end of the preform until said predefined tension is reached.

9. The apparatus of claim 8, wherein said tensioning means further comprises securing means for securing the first end of the preform after said predefined tension is reached.

10. The apparatus of claim 9, wherein said tensioning means further comprises means for disconnecting said pulling means from the preform first end after the first end of the preform is secured by said securing means.

11. The apparatus of claim 7, wherein said tensioning means comprises:
a wheel configured to freely rotate around an axis perpendicular to the longitudinal axis of the preform;
a line looped around said wheel, said line having a proximal end and a distal end, said proximal end being attached to the first end of the preform; and
a counterweight of a predefined magnitude attached to said distal end of said line, said counterweight magnitude being selected to apply said predefined tension to the preform.

12. The apparatus of claim 11, further comprising means for:
(a) after said predefined tension is applied to the preform, securing the first end of the preform; and
(b) disconnecting said line proximal end from the preform first end.

13. The apparatus of claim 7, wherein said tensioning means comprises:
a wheel configured to freely rotate around an axis perpendicular to the longitudinal axis of the preform; and
a counterweight of a predefined magnitude, wherein the preform first end is looped around said wheel and attached said counterweight, said counterweight magnitude being selected to apply said predefined tension to the preform.

14. The apparatus of claim 13, wherein the preform passes through said feeding means before entering said tensioning means, further comprising means for:
(a) after said predefined tension is applied to the preform, securing a portion of the preform within said feeding means; and
(b) severing the preform above said secured portion.

15. The apparatus of claim 7, wherein said tensioning means comprises a motor connected to the preform first end, operable to pull the preform first end until said predefined tension is applied to the preform.

16. The apparatus of claim 15, wherein the preform passes through said feeding means before entering said tensioning means, further comprising means for:
(a) after said predefined tension is applied to the preform, securing a portion of the preform within said feeding means; and
(b) severing the preform above said secured portion.

17. The apparatus of claim 7, wherein said tensioning means comprises:
a line having a proximal end and a distal end, said proximal end being attached to the first end of the preform; and
a motor connected to said distal end of the line, operable to pull said line until said predefined tension is applied to the preform.

18. The apparatus of claim 17, further comprising means for:
(a) after said predefined tension is applied to the preform, securing the first end of the preform; and
(b) disconnecting said line proximal end from the preform first end.

19. The apparatus of claim 1, wherein a diameter D_{f} of the drawn and twisted optical fiber is defined by the following expression:
$${D}_{f} = {D}_{p} \sqrt{\frac{{V}_{f}}{{V}_{d}}}$$
wherein, Dₚ is a diameter of the preform, V_{f} is said feeding speed and V_{d} is said drawing speed.

20. The apparatus of claim 1, wherein a pitch P of the drawn and twisted optical fiber is defined by the following expression:
$$P = \frac{{V}_{d}}{R}$$
wherein, V_{d} is said drawing speed and R is said twisting speed.

21. The apparatus of claim 1, wherein said heating means comprises a central portion, said heating means further comprising first heat control means for imposing a substantially flat transverse heat distribution perpendicular to the preform and the optical fiber drawn therefrom in said central portion of said heating means.

22. The apparatus of claim 21, wherein said first heat control means comprise at least one of: insulating means disposed within said heating means, and active cooling means applied to at least portion of said heating means.

23. The apparatus of claim 21, wherein said heating means comprises an upper portion for receiving the preform and a bottom portion for releasing the optical fiber, said heating means further comprising a second heat control means for imposing a longitudinal heat distribution along the preform and the optical fiber drawn therefrom, said longitudinal heat distribution increasing from a minimal temperature at said upper portion of said heating means to a peak process temperature, said peak being positioned at said central portion of said heating means, and dropping to said minimal temperature approximately immediately after said central portion of said heating means.

24. The apparatus of claim 23, wherein said second heat control means comprise at least one of: insulating means disposed within said heating means, and active cooling means applied to at least portion of said heating means.

25. The apparatus of claim 21, wherein said heating means comprises an upper portion for receiving the preform and a bottom portion for releasing the optical fiber, said heating means further comprising a third heat control means for imposing a longitudinal heat distribution along the preform and the optical fiber drawn therefrom, said longitudinal heat distribution sharply increasing to a peak process temperature at said central portion of said heating means and remaining at a substantially minimal level in other portion of said heating means.

26. The apparatus of claim 25, wherein said third heat control means comprise at least one of: insulating means disposed within said heating means, and active cooling means applied to at least portion of said heating means.

27. The apparatus of claim 3, further comprising tensioning means for applying a predefined tension to the preform, wherein said control unit is further operable to:
(a) prior to activation of said feeding means, said heating means, and said drawing means, activate said tensioning means to apply said predefined tension to the preform;
(b) cause said feeding means to feed the preform at a first feeding speed, and cause said drawing means to draw the preform at said predefined drawing speed, wherein said first feeding speed is equal to said predefined drawing speed;
(c) activate said heating means to increase an internal temperature from an initial temperature to said process temperature; and
(d) while increasing said internal temperature from said initial temperature to said process temperature, decrease said first feeding speed such that said first feeding speed reaches said predefined feeding speed when said internal temperature reaches said process temperature.

28. The apparatus of claim 1, wherein said heating means comprises a longitudinal heating chamber surrounding the preform, the preform being disposed along a central longitudinal axis of said heating chamber, and wherein said heating chamber comprises an elongated cross section such that heat distribution applied to the preform is uneven but symmetrical along the sides of the preform.

29. The apparatus of claim 28, wherein the preform comprises a solid glass element.

30. A method for fabricating an optical fiber having a modulation of the dielectric constant along its longitudinal axis from a preform having a first end and a second end, the method comprising the steps of:
(a) securing the first end of the preform;
(b) feeding the preform at a predefined feeding speed through a heating unit;
(c) heating the preform to a predefined process temperature at a predetermined location in said heating unit, said process temperature being sufficient to cause the preform to be susceptible to drawing and twisting; and
(d) engaging the second end of the preform;
(e) drawing the preform through said heating unit at a predefined drawing speed to produce the optical fiber drawn from the preform at said predetermined location within said heating unit, said drawing speed being greater than or equal to said feeding speed; and
(f) twisting the optical fiber around the longitudinal axis at a predefined twisting speed, at said predetermined location, to produce a twisted optical fiber having a periodic modulation of the dielectric constant along the longitudinal axis.

31. The method of claim 30, wherein the preform comprises at least one of:
(a) at least one hole along the longitudinal axis;
(b) at least one groove in the surface of the preform along the longitudinal axis;
(c) a first elongated quarter-cylindrical portion comprised of a first material, a second elongated quarter-cylindrical portion comprised of a second material, in contact with said first portion, a third elongated quarter-cylindrical portion comprised of a first material in contact with said second portion, and a fourth elongated quarter-cylindrical portion comprised of a second material in contact with said third and said first portions, said first, second, third and fourth portions being arranged clockwise starting from said first portion;
(d) a first elongated half-cylindrical portion comprised of a first material and a second elongated half-cylindrical portion comprised of a second material, said first and second portions having their flat surfaces in contact with one another;
(e) at least two elongated elements in contact with one another along a common longitudinal axis; and
(f) an outer cladding material and an inner core material along a central longitudinal axis, said outer cladding material having a circular cross-section, and said inner core material having one of: an elliptical cross-section and a rectangular cross-section.

32. The method of claim 30, further comprising the step of:
(g) providing a control unit operable to: control and vary at least one of: said predefined feeding speed, said predefined process temperature, said predefined drawing speed, and said predefined twisting speed.

33. The method of claim 30, further comprising the step of:
(h) imposing a predefined tension on the preform, prior to said step (a).

34. The method of claim 33, wherein said step (h) further comprises the steps of:
(i) securing the second end of the preform; and
(j) pulling the first end of the preform until said predefined tension is reached.

35. The method of claim 30, wherein a diameter D_{f} of the drawn and twisted optical fiber is defined by the following expression:
$${D}_{f} = {D}_{p} \sqrt{\frac{{V}_{f}}{{V}_{d}}}$$
wherein, Dₚ is a diameter of the preform, V_{f} is said feeding speed and V_{d} is said drawing speed.

36. The method of claim 30, wherein a pitch P of the drawn and twisted optical fiber is defined by the following expression:
$$P = \frac{{V}_{d}}{R}$$
wherein, V_{d} is said drawing speed and R is said twisting speed.

37. The method of claim 30, further comprising the step of:
(k) imposing a substantially flat transverse heat distribution perpendicular to the preform in said predetermined portion of said heating unit.

38. The method of claim 30, further comprising the step of.
(l) imposing a longitudinal heat distribution along the preform and the optical fiber drawn therefrom, said longitudinal heat distribution increasing from a minimal temperature at a point of entry of the preform into the said heating unit to a peak process temperature at said predetermined location within the heating unit, and dropping to said minimal temperature approximately immediately after said predetermined location.

39. The method of claim 30, further comprising the step of:
(m) imposing a longitudinal heat distribution along the preform and the optical fiber drawn therefrom, said longitudinal heat distribution sharply increasing to a peak process temperature at said predetermined portion in said heating unit, and remaining at a substantially minimal level in other portions of said heating unit.

40. The method of claim 30, further comprising the steps of:
(n) prior to said step (a), applying a predefined tension to the preform;
(o) at said step (b) feeding the preform at a first feeding speed;
(p) at said step (e) drawing the preform at said predefined drawing speed, wherein said first feeding speed is equal to said predefined drawing speed;
(q) at said step (c) increasing an internal temperature of said heating unit from an initial temperature to said process temperature; and
(r) while increasing said internal temperature from said initial temperature to said process temperature, decreasing said first feeding speed such that said first feeding speed reaches said predefined feeding speed when said internal temperature reaches said process temperature.
